(19) United States
(12) Patent Application Publication
(10) Pub. No.: US 2015/0035479 A1
(43) Pub. Date: Feb. 5, 2015

(54) BATTERY CHARGER

(71) Applicant: ELITE LIFESTYLE PRODUCTS L.P., MONTREAL (CA)

(72) Inventor: Clifford A. Wright, San Diego, CA (US)

(21) Appl. No.: 14/446,986

(22) Filed: Jul. 30, 2014

Related U.S. Application Data
(60) Provisional application No. 61/860,049, filed on Jul. 30, 2013.

(51) Int. Cl. H02J 7/00

(52) U.S. Cl. CPC H02J 7/0045; H02J 7/0047; H02J 7/0052
USPC 320/107

(57) ABSTRACT

A portable battery charger for charging a portable battery. The battery charger has a body defined by an outer surface, a top surface, and a bottom surface. The outer and bottom surfaces are shaped and sized to be insertable into a receptacle. The charger also has a battery-charging slot extending into the body from the top surface for receiving and charging the battery, and a power input for transferring electrical power to the body. The charger also has an energy storage housed within the body and in electrical communication with the battery-charging slot and the power input, for storing and transferring the electrical power.

### CROSS-REFERENCE TO RELATED APPLICATIONS

This application claims priority on U.S. patent application Ser. No. 61/860,049 filed on Jul. 30, 2013, the entire contents of which are incorporated by reference herein.

### TECHNICAL FIELD

The application relates generally to devices which supply electrical power and, more particularly, to a battery charger and battery charging system.

### BACKGROUND OF THE ART

Electrical power is supplied to all manner of portable devices. It is known, for example, to use a vehicle's electrical supply to power the batteries of portable devices such as mobile phones. However, many current devices which use the vehicle's electrical supply are cumbersome, and do not secure the portable device, or its battery, in place within the vehicle as it is driven. Furthermore, many current devices are limited to being used in the vehicle because they must be plugged into the vehicle's 12 V battery-power system, and are thus incapable of supplying electrical power away from the immediate vicinity of the vehicle.

### SUMMARY

In one aspect, there is provided a portable battery charger, comprising: a body having an outer surface extending between a top surface and a bottom surface, the outer and bottom surfaces of the body shaped and sized to be insertable into a receptacle and secured therein by a friction fit; a battery-charging slot extending into the body from the top surface, the battery-charging slot in use receiving a battery to be charged and transferring electrical power thereto; at least one power input disposed on the top surface of the body, the at least one power input in use transferring electrical power to the body; and an energy storage housed within the body and in electrical communication with the battery-charging slot and the at least one power input.

In another aspect, there is provided a battery charging system, comprising: a portable battery charger, comprising: a body having an outer surface extending between a top surface and a bottom surface, the outer and bottom surfaces of the body shaped and sized to be insertable into a receptacle and secured therein by a friction fit; a battery-charging slot extending into the body from the top surface, the battery-charging slot in use receiving a battery to be charged and transferring electrical power thereto; at least one power input disposed on the top surface of the body, the at least one power input in use transferring electrical power to the body; and an energy storage housed within the body and in electrical communication with the battery-charging slot and the at least one power input; and a power adapter having an adapter body defining a mounting bracket removably mountable to the body of the battery charger, the mounting bracket having a locking mechanism in use engaging the body and a power output mountable to the at least one power input of the battery charger to supply electrical power thereto, the power adapter also having a power socket disposed on the adapter body to receive electrical power from an external power source.

### DESCRIPTION OF THE DRAWINGS

Reference is now made to the accompanying figures in which:

FIG. 1A is a perspective view of a battery charger, according to an embodiment of the present disclosure;

FIG. 1B is another perspective view of the battery charger of FIG. 1A;

FIG. 1C is a top view of the battery charger of FIG. 1A;

FIG. 2 is a perspective view of a battery charging system having a battery charger as shown in FIG. 1A and a power adapter, according to another embodiment of the present disclosure; and

FIG. 3 is a perspective view of the power adapter of FIG. 2.

### DETAILED DESCRIPTION

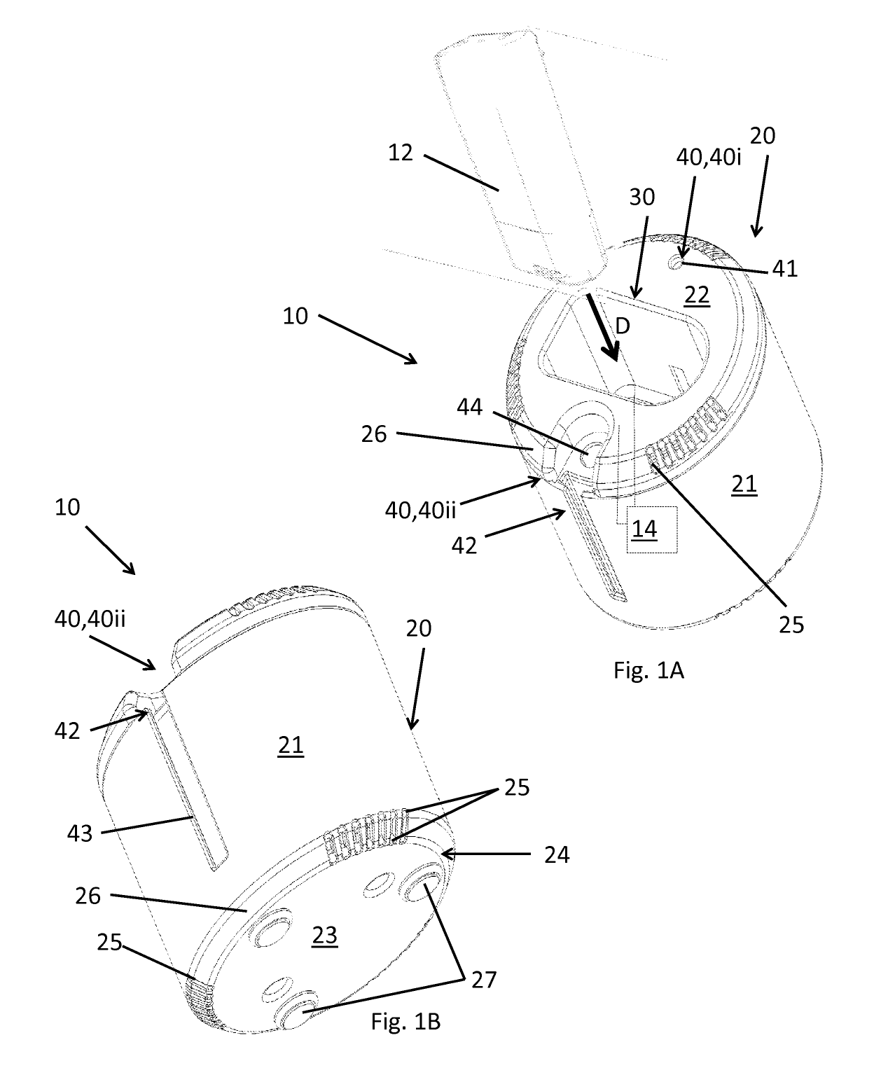

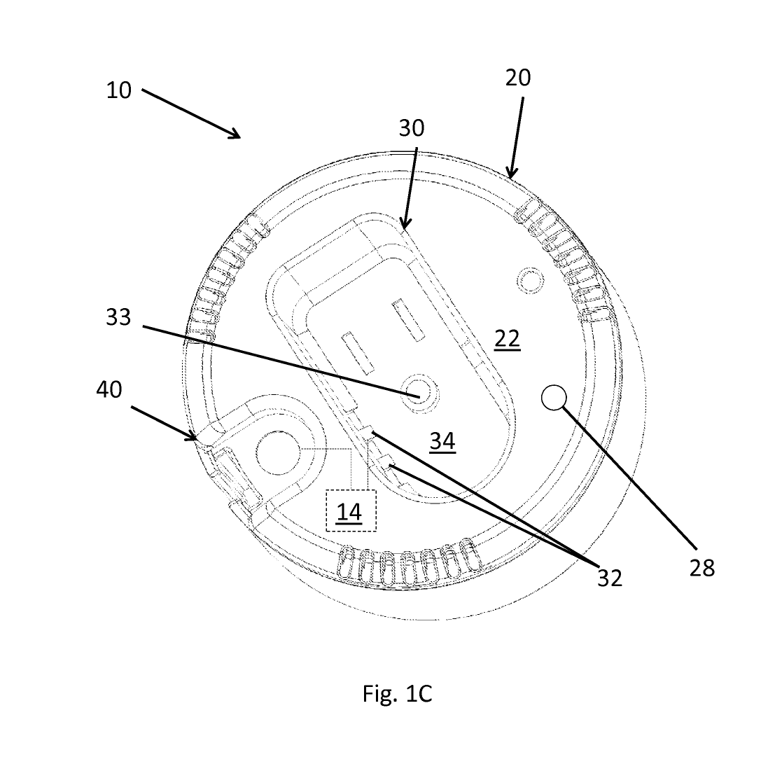

FIGS. 1A and 1B illustrate a portable battery charger 10 for charging a battery 12. The battery charger 10 is portable (mobile) such that it can be used to recharge a battery, even when the battery charger 10 is not connected to a power source (e.g. 120V AC power or 12V DC power, for example). The battery charger 10 accordingly receives and stores electrical power, and transfers it to the battery 12, to thereby recharge the rechargeable battery 12, when the two are connected. This enables the battery 12 to be recharged in any desired remote location, even when other power sources are not readily nearby.

The battery 12 is a rechargeable battery which supplies electrical power to any suitable device, such as small electronic devices and/or appliances for example. Some non-limiting examples of batteries 12 within the scope of the present disclosure include nickel-cadmium (NiCd), nickel-zinc (NiZn), nickel metal hydride (NiMH), and lithium-ion (Li-ion) cells.

The battery charger 10 is portable and can therefore be transported to any location where it is needed to charge the battery 12. One such location, amongst many possible choices, is a vehicle such as a car, truck, or boat. Indeed, and as will be described in greater detail below, the battery charger 10 can be secured within a cup holder slot in the vehicle. This enables the battery charger 10 to remain easily accessible, when needed, to recharge the battery 12. Further, when positioned within a vehicle's cup holder, the battery charger 10 can also be readily connected to a power source for the purposes of re-charging the charger 10, whereby the charger 10 is supplied with electrical power from the car's electrical supply (e.g. 12V DC) so as to restore the capacity of the charger 10. It can thus be appreciated that the battery charger 10 serves as a mobile and displaceable charging station for the battery 10. Such portability allows the user of the battery charger 10 to transport the partially or fully charged battery charger 10 to a location of their choice, and to use the battery charger 10 to charge the battery 12 only when desired. It will be appreciated that the battery charger 10 thus serves as a portable “battery” for the battery 12, in the sense that the portable charger 10 is itself first charged by a power source, whereafter the portable charger 10 can then be used remotely to re-charge the battery 12 used in an electrical device(s).

The battery charger 10 generally includes a body 20, a battery-charging slot 30 for receiving and charging the battery 12, one or more power inputs 40 for supplying the battery charger 10 with electrical power, and an energy storage 14 for storing and conveying electrical power to the battery 12 when connected to the charger 10

The body 20 forms the corpus of the battery charger 10 and provides structure thereto. The body 20 is typically hollow and houses suitable internal components and electrical circuitry which allow it to receive electrical power from a separate supply and transfer it to the battery 12. The battery charger 10 is generally intended to be placed within a receptacle, such as the cup holder slot of a vehicle. The body 20 is therefore shaped and sized to match the shape and size of the receptacle (e.g. cup holder slot). Such a shape is generally, but not exclusively, cylindrical, as shown in FIGS. 1A and 1B. Irrespective of its shape, the body 20 is defined by an outer surface 21, a top surface 22, and a bottom surface 23.

The outer, top, and bottom surfaces 21,22,23 define the contour and shape of the body 20. In the embodiment shown in FIGS. 1A and 1B, the body 20 is a cylinder and the outer surface 21 is therefore rounded. It will be appreciated that since the body 20 can assume other shapes, so too can the outer, top, and bottom surfaces 21,22,23. The outer surface 21 extends between and connects the top surface 22 and the bottom surface 23. The top surface 22 is the surface of the body 20 which is visible when the body 20 is placed on its resting surface in the receptacle, while the bottom surface 23 is the surface which is hidden when the body 20 is placed on the resting surface.

The outer and bottom surfaces 21,23 of the body 20 are shaped and sized to be inserted into, and removed from, a receptacle such as a cup holder. Once so inserted, the receptacle will enclose the bottom surface 23 entirely, and at least part of the outer surface 21. As discussed above, the receptacle is generally a cup holder slot of a vehicle. Once so inserted, the outer and bottom surfaces 21,23 may form a friction fit with the inner surfaces of the receptacle. The expression “friction fit” refers to the increased frictional contact between the outer and bottom surfaces 21,23 and the inner surfaces of the receptacle when the body is inserted therein, such that removal of the body 20 from the receptacle requires the user of the battery charger 10 to apply a certain force to the body 20.

The body 20 can be made of any suitable material. For example, if the battery charger 10 is intended to be placed in the cup holder slot of a vehicle, the body 20 can be made of a resilient material such as silicone rubber which allows the body 20 to deform to match the shape of the cup holder slot to be placed therein, and which returns the body 20 to its original shape when removed from the cup holder slot, thereby allowing the friction fit. Alternatively, the body 20 can be made of a more firm but still resilient material which allows the body to be pressure or friction fitted into the cup holder slot. In yet another alternative, the body 20 can be made of a rigid polymer and sized and shaped to match the dimensions of standard cup holder slots. It can thus be appreciated that the body 20 can be made of many different materials, the selection of which is largely dependent on of the intended use of the battery charger 10.

The battery charger 10 also has one or more battery-charging slots 30 (or simply “charging slot 30”). Each charging slot 30 receives the battery 12 therein, such as along the direction indicated by the arrow D in FIG. 1A. The charging slot 30 also allows electrical power to be transferred to the battery 12. In the embodiment of FIGS. 1A and 1B, the charging slot 30 is a groove or opening which extends into the body 20 from the top surface 22. It is appreciated that the charging slot 30 may also extend into the body 20 from a side surface, such as the outer surface 21, depending on the desired accessibility of the charging slot 30 and the intended use of the battery charger 10, amongst other possible factors. The shape of the charging slot 30 shown in FIG. 1A can vary and is primarily dependent on the shape of the battery 12 to be received therein (i.e. the charging slot 30 has a profile/shape which corresponds or is complementary to that of the battery 12). The shape of the inner surfaces of the charging slot 30 can therefore match the peripheral surface of the battery 12 to be inserted therein, thereby helping to secure the battery 12 within the charging slot 30. The number of charging slots 30 for a given battery charger 10 can also vary, and is not limited to the single charging slot 30 shown in FIGS. 1A and 1B. Indeed, the battery charger 10 can have more than one charging slot 30, where each charging slot 30 is configured to receive a corresponding battery 12 therein.

The one or more power inputs 40 of the battery charger 10 receive electrical power from an external power source and transfer it through the internal electrical circuitry of the body 20 and, directly or indirectly, to the battery 12. Each power input 40 can therefore be any port, socket, or connector. Each one of the power inputs 40 is located on the top surface 22, the outer surface 21, or both, so that it can be readily accessible by the user when the battery charger 10 is placed against the resting surface. However, in the depicted embodiment whereby the battery charger 10 is shaped and configured so as to fit snugly within a circular cup holder receptacle of a vehicle, it is advantageous for the power input(s) 40 to be located on the top surface 22 of the charger 10. Accordingly, when the battery charger 10 is disposed within the cup holder receptacle of the vehicle, a power supply wire (e.g. from the vehicles 12V DC electrical system, for example) can be connected with the power input 40 of the charger 10 (such as to either directly power or “re-charge” the charger 10) without it needing to be removed from within the cup holder.

When directly connected to an external power source, via the input(s) 40, the external power source may be used to directly charge the battery 12 within the charger 10. However, the battery charger 10 also stores electrical power supplied to it, in addition to being able to convey electrical power directly to the battery. The battery charger 10 therefore includes an energy storage 14, which is housed within the body 20. The energy storage 14 is in electrical communication with the battery-charging slot 30 and with the one or more of the power inputs 40, as shown schematically in FIG. 1A. This allows the energy storage 14 to receive electrical power from the one or more power inputs 40, to store it, and to later transfer it to the battery via the charging slot 30. As such, the energy storage 14 can include a capacitor, a battery, or other similar electrical energy storage device. Alternatively, the energy storage 14 can be configured to allow the electrical power received from the power inputs 40 to bypass the energy storage 14 altogether, and be transferred directly to the charging-slot 30 and ultimately, to the battery 12 contained therein. It can thus be appreciated that such an energy storage 14 allows the battery charger 10 to be portable so that it can be used to charge the battery 12 remotely of the supply from which the battery charger 12 itself received electrical power.

The number and configuration of the power inputs 40 may vary. In the embodiment shown in FIGS. 1A and 1B, the battery charger 10 has two different power inputs 40i,40ii.

The power input 40i has a first power connector 41 located on the top surface 22 of the body 20 which extends into the body 20 from the top surface 22. The first power connector 41 can be any socket or port which allows a first input of electrical power to the internal circuitry of the body 20. Consider again the example where the battery charger 10 is to be secured into a cup holder slot of a vehicle. The first power connector 41 allows for part of the vehicle's electrical power supply to be supplied to the battery charger 10, via suitable electrical cable. This can be achieved as per the following example: a cable joins the first power connector 41 to the outlet of the cigarette lighter of a car. This allows the car's 12 V electrical power supply to provide electrical power to the power input 40i via the cigarette lighter outlet and the first power connector 41. This electrical power can be supplied at 12 V, or at any other suitable voltage. This configuration of the power input 40i can be particularly suitable where it is desired to power the battery charger 10 from a vehicle.

The power input 40ii has a second power connector 42. The second power connector 42 has a locking channel 43 and a connector opening 44. The locking channel 43 is an elongated groove which extends into the body 20 from the outer surface 21, and which extends along a vertical direction beginning at the top surface 22. The locking channel 43 receives a corresponding mating part so as to secure that part to the body 20. The connector opening 44 is a socket which is connected to the internal circuitry of the battery charger 10. In use, the connector opening 44 receives the prong(s) or pin(s) of a plug so that electrical power can be transferred into the battery charger 10 via the connector opening 44. The second power connector 42 can be particularly suited to supplying the battery charger 10 with electrical power from an external power source, such as mains power via an electrical outlet, as will be discussed in further detail below, and where it is desired to transfer electrical power at higher standard voltages (e.g. 110 V, 120 V, or 220 V) than can be transferred via the first power connector 41. It will be appreciated that the battery charger 10 can be equipped with one, or both, of the first and second power connectors 41,42.

In some embodiments, the body 20 may have a peripheral friction element 24 which helps to keep the body 20 in position. The peripheral friction element 24 of the body 20 is located on either the outer surface 21, the bottom surface 23, or both. The friction element 24 is thus located on an outside boundary or perimeter of the body 20, which allows it to engage with the inner surface of the receptacle against which the battery charger 10 is ultimately placed. The friction element 24 increases the frictional contact with the inner surface, thereby helping to reduce movement of the outer or bottom surfaces 21,23 on which the friction element 24 is located with respect to the inner surface. Said differently, the friction element 24 helps to maintain the body 20, and thus the battery charger 10, in position within the receptacle. The friction element 24 can therefore be made of any material which helps it to reduce relative movement of the body 20. Some of these materials include, but are not limited to, rubber, rough textiles, and other friction-enhancing materials. Similarly, it will be appreciated that the friction element 24 can have numerous configurations in order to achieve such functionality, some of which are now discussed in greater detail.

The friction element 24 may include a plurality of friction slots 25, each one of which extends into the body 20. Each slot 25 is located between the bottom surface 23 and the outer surface 21, along a peripheral chamfered edge 26. The slots 25, whether alone or in a grouping of multiple slots, help the user to grip and retain the body 20. As such, and if desired, the slots 25 can also be provided along a chamfered edge 26 between the top surface 22 and the outer surface 21.

The friction element 24 may also include, in addition to the slots 25 or independently thereof, one or more friction pads 27 located on the bottom surface 23 of the body 20. The friction pads 27 can be any textured, ribbed, pointed, adhesive, or other friction-enhancing surface which engages the bottom inner surface of the receptacle so as to reduce or prevent movement of the body 20 with respect to the bottom inner surface. The arrangement of the friction pads 27 along the bottom surface 23 can vary, and is not limited to the three friction pad 27 configuration shown in FIG. 1B.

FIG. 1C provides an example showing how the battery may be secured into the battery-charging slot 30. The charging slot 30 may have one or more input connectors 32 which are located in the body 20 near a base 34 of the charging slot 30. The input connectors 32 engage corresponding terminals of the battery to transfer electrical power thereto, when the battery is secured in position within the charging slot 30. The battery can be secured in its charging position within the charging slot 30 via one or more securing pegs 33 which project vertically away from the base 34 and/or into the charging slot 30. The securing pegs 33 engage corresponding openings in the bottom of the battery so as to secure the battery within the charging slot 30 such that movement of the body 20, as caused by a vehicle's movement, will not act to dislodge or otherwise eject the battery from the charging slot 30.

It may also be desirable to provide a charge indicator 28 on a visible portion of the body 20, such as the top surface 22 or outer surface 21, which indicates the charging status of the battery or the battery charger 10. The charge indicator 28 can take many different forms, such as that of a light-emitting diode (LED) which shows the colour red when the battery or battery charger 10 is not fully charged, and green when the battery or battery charger 10 is fully charged.

An example of the placement and use of the battery charger 10 will now be described with reference to FIGS. 1A to 1C. The body 20 of the battery charger 10 is placed within a cup holder slot of a car. The interior of the cup holder slot is the receptacle for the purposes of this example. Since cup holder slots generally have circular cross-section openings and are adapted to receive cups therein, the outer surface 21 of the body 20 accordingly has a generally circular perimeter and corresponding circular cross-sectional profile. The body 20 is shaped and sized to be insertable into the cup-holder slot by snug, pressure or friction fit. Alternatively, the body 20 can be more loosely placed within the cup holder slot and its relative movement restricted by the one or more friction elements 24 discussed herein. Irrespective of how relative movement of the body 20 is reduced or eliminated, the body 20 is securely positioned within the cup holder slot such that the motion of the car will not easily dislodge it.

If the battery charger 10 is not already fully charged, electrical power can be supplied to the battery charger 10, and thus the battery 12 when connected therein, either via the first power connector 41, the second power connector 42, or both. This electrical power is transferred directly to the battery 12, or can be stored in the energy storage 14 for transferral to the battery 12 at a later time. If electrical power is transferred to the energy storage 14, the battery charger 10 can be removed from the cup holder slot and transported with a user. When a user wishes to charge a battery 12, the user can simply insert the battery 12 into the charged battery-charger 10 via the charging slot 30, even when the battery charger 10 is not connected to any other power supply source.

It can be appreciated that such a battery charger 10 is useful as a portable charging station, and whenever it is desired to have a portable source of electrical power. This is often the case when camping. The battery charger 10 can be used to charge a host of different portable camping devices such as a lantern, flashlight, or mobile telephone, for example only.

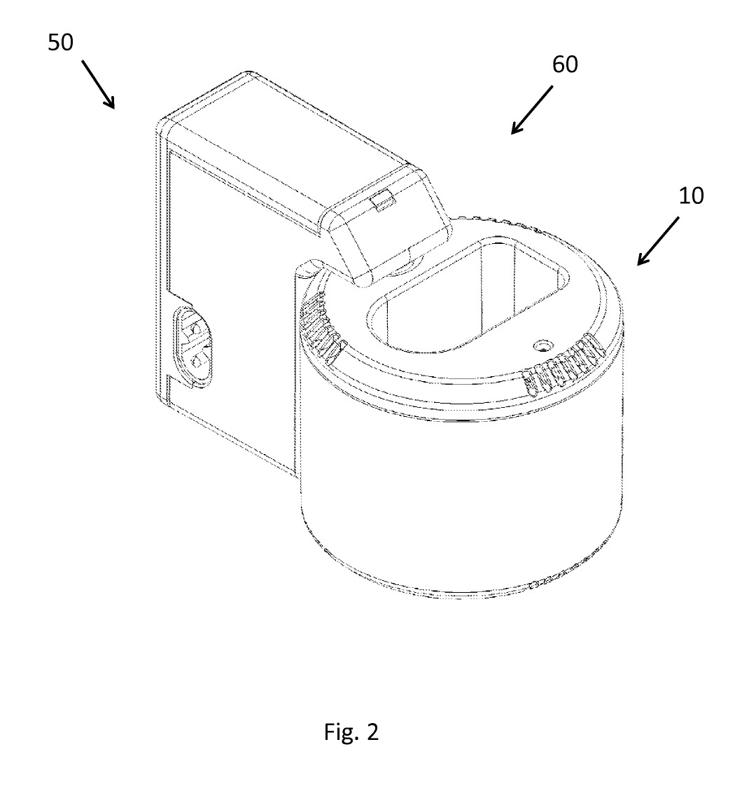

There is also disclosed, with reference to FIG. 2, a battery charging system 60. In addition to the battery charger 10 disclosed herein, the charging system 60 has an AC power adapter 50 which transfers an external supply of electrical power to the battery charger 10 for storage therein and/or direct charging of the battery therein. The power adapter 50 can be used, for example, where the car's electrical power is not available to charge the battery charger 10. In such a situation, the battery charger 10 can be charged with the power adapter 50, which receives electrical power from an outlet source and stores electrical power. It can thus be appreciated that the charging system 60 allows the battery charger 10 to remain in place, such as in a cup holder slot of a car, because the power adapter 50 can be brought to the battery charger 10 to provide a charge wherever it is located.

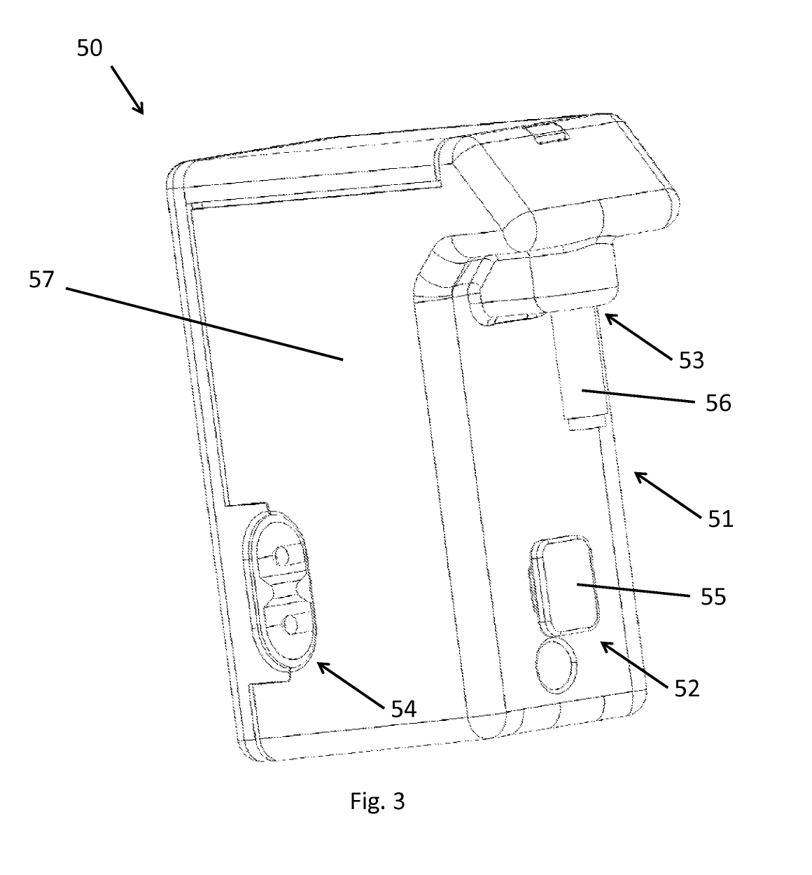

An embodiment of the power adapter 50 is shown in FIG. 3. The power adapter 50 has an adapter body 57 which makes up the structure of the power adapter 50 and allows it to be mounted to, and removed from, the battery charger. The adapter body 57 is both secured to the battery charger, and forms an electrical connection with the battery charger to transfer electrical power thereto. The power adapter 50 has a mounting bracket 51 which engages the body of the battery charger, and a power socket 54 to receive electrical power from an external power source.

The mounting bracket 51 both secures the power adapter 50 to the battery charger, and forms an electrical connection with the battery charger to transfer electrical power thereto. The mounting bracket 51 has a locking mechanism 52 which engages the body of the battery charger, and a power output 53 which engages a corresponding power input of the battery charger to supply electrical power to thereto. It can thus be appreciated that many configurations of the mounting bracket 51 are within the scope of the present disclosure.

For example, in the embodiment described above where one of the power inputs of the battery charger has a second power connector with a locking channel and a connector opening, the locking mechanism 52 of the mounting bracket 51 can include a slide lock 55 which can be inserted into the locking channel and displaced therein, thereby preventing the power adapter 50 from disengaging the battery charger. The power output 53 of such a mounting bracket 51 can include a prong connector 56 which can be inserted into, and removed from, the connector opening of the second power connector to supply electrical power thereto. This supply can be at a higher voltage (e.g. 110 V, 120 V, or 220 V).

The power socket 54 can be any hollow part into which an electric plug can be inserted. The power socket 54 allows the power adapter to receive electrical power from the external power source, such as a standard 120 V or 220 V electrical outlet, thereby charging the power adapter 50 and/or transferring electrical power to the battery charger.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A portable battery charger, comprising:
a body having an outer surface extending between a top surface and a bottom surface, at least the outer and bottom surfaces of the body shaped and sized to be insertable into a receptacle;
a battery-charging slot extending into the body from the top surface, the battery-charging slot in use receiving a battery to be charged and transferring electrical power thereto;
at least one power input disposed on the top surface of the body, the at least one power input in use transferring electrical power to the body; and
an energy storage housed within the body and in electrical communication with the battery-charging slot and the at least one power input.

2. The battery charger of claim 1, wherein the outer and bottom surfaces of the body are shaped and sized to be insertable into a cup holder slot of a vehicle.

3. The battery charger of claim 2, wherein the body is insertable into the cup holder slot of the vehicle and secured therein by a friction fit.

4. The battery charger of claim 1, wherein the outer surface of the body has a circular periphery shaped and sized to be insertable into an opening of the receptacle having a circular cross-section.

5. The battery charger of claim 1, wherein the body has a peripheral friction element having at least one friction pad disposed on the bottom surface of the body.

6. The battery charger of claim 1, wherein the at least one power input has a first power connector disposed on the top surface of the body and extending therein.

7. The battery charger of claim 1, further comprising a second power connector having a locking channel extending into the body from the outer surface and vertically downward from the top surface, and a connector opening extending into the body from the top surface.

8. The battery charger of claim 1, wherein the battery-charging slot has a plurality of input connectors disposed about a base of the battery-charging slot within the body, and at least one securing peg projecting vertically away from the base of the battery-charging slot.

9. The battery charger of claim 1, wherein at least one of the top surface and the outer surface of the body has a charge indicator indicative of a charging status of the battery or battery charger.

10. A battery charging system, comprising:
a portable battery charger, comprising:
a body having an outer surface extending between a top surface and a bottom surface, at least the outer and bottom surfaces of the body shaped and sized to be insertable into a receptacle;
a battery-charging slot extending into the body from the top surface, the battery-charging slot in use receiving a battery to be charged and transferring electrical power thereto;
at least one power input disposed on the top surface of the body, the at least one power input in use transferring electrical power to the body; and
an energy storage housed within the body and in electrical communication with the battery-charging slot and the at least one power input; and
a power adapter having an adapter body defining a mounting bracket removably mountable to the body of the battery charger, the mounting bracket having a locking mechanism in use engaging the body and a power output mountable to the at least one power input of the battery charger to supply electrical power thereto, the power adapter also having a power socket disposed on the adapter body to receive electrical power from an external power source.

11. The battery charging system of claim 10, wherein the outer and bottom surfaces of the body of the battery charger are shaped and sized to be insertable into a cup-holder of a vehicle.

12. The battery charging system of claim 11, wherein the body is insertable into the cup holder slot of the vehicle and secured therein by a friction fit.

13. The battery charging system of claim 10, wherein the outer surface of the body has a circular periphery shaped and sized to be insertable into an opening of the receptacle having a circular cross-section.

14. The battery charging system of claim 10, wherein the body has a peripheral friction element having at least one friction pad disposed on the bottom surface of the body.

15. The battery charging system of claim 10, wherein the at least one power input of the battery charger has a first power connector disposed on the top surface of the body and extending therein.

16. The battery charging system of claim 10, further comprising a second power connector having a locking channel extending into the body from the outer surface and vertically downward from the top surface, and a connector opening extending into the body from the top surface.

17. The battery charging system of claim 16, wherein the locking mechanism of the mounting bracket has a slide lock insertable within the locking channel of the second power connector and displaceable therein.

18. The battery charging system of claim 16, wherein the power output of the mounting bracket has a prong connector insertable into the connector opening of the second power connector to supply electrical power thereto.

19. The battery charging system of claim 10, wherein the battery-charging slot has a plurality of input connectors disposed about a base of the battery-charging slot within the body, and at least one securing peg projecting vertically away from the base of the battery-charging slot.

20. The battery charging system of claim 10, wherein at least one of the top surface and the outer surface of the body of the battery charger has a charge indicator indicative of a charging status of the battery.
